(19) United States
(12) Patent Application Publication
(10) Pub. No.: US 2002/0135100 A1
(43) Pub. Date: Sep. 26, 2002

(54) Process for the production of a coated tie rod for a doorstop device for vehicles

(76) Inventor: Vittorio Audisio, Bianze (IT)

Correspondence Address: TRASK BRITT, P.O. BOX 2550, SALT LAKE CITY, UT, 84110, US

(21) Appl. No.: 09/815,368

(22) Filed: Mar. 22, 2001

(51) Int. Cl. B29C 45/14

(52) U.S. Cl. 264/275; 264/278

(57) ABSTRACT

Process for the production of a coated tie rod (16) for a doorstop device (10) for vehicles, in which the tie rod (16) has an articulation hole (38) at one first end (16a) and a pair of rolling surfaces (20, 22) designed to co-operate with a pair of rollers (26, 28). The process comprises the steps of: positioning a metal core (34) in a moulding apparatus (44) and injecting plastic material into a moulding seat (50) surrounding the metal core (34).

The metal core (34) is positioned with respect to the moulding seat (50) using first positioning means (52, 54) which co-operate with the articulation hole (38), and using second positioning means (60) which cooperate with an appendage (40) formed at a second end (16b) of the metal core (34).

### BACKGROUND OF THE INVENTION

1. Field of the Invention

The present invention relates to a process for the production of a coated tie rod for a doorstop device for vehicles.

2. State of the Art

The present invention has been developed in particular for the production of a doorstop device comprising a first support designed to be fixed to the upright of a vehicle and a second support designed to be fixed to an oscillating door, and including a tie rod having one end articulated to the first support and having two rolling surfaces set opposite to one another, which cooperate with a pair of idle rollers carried by the second support and pressed elastically against one another. In doorstop devices of this type it has already been proposed to coat the tie rod with a layer of plastic material with the aim of eliminating the noise of the device due to the relative movement between the tie rod and the rollers during opening and closing of the door.

The application of the coating of plastic material on the tie rod is performed by means of a co-moulding operation in the course of which a metal core is positioned in a moulding seat into which plastic material is injected, which forms the layer of coating. One of the problems that emerges during the production of coated tie rods lies in the fact that existing co-moulding processes are unable to guarantee that the coating will have a uniform thickness. If the tie rod has a smaller thickness in an area of the rolling surface that is subjected in operation to high specific pressure in use, the coating of plastic material tends to get damaged and to produce fracture points.

### SUMMARY OF THE INVENTION

The purpose of the present invention is to provide a process for the production of a coated tie rod for a doorstop device for vehicles of the type defined in the preamble of claim 1 that is simple to use at an industrial scale and enables a coating with a uniform thickness to be obtained.

According to the present invention, the above purpose is achieved mainly by a process having the characteristics that form the subject of claim 1.

Further secondary characteristics of the process according to the invention are defined in the subordinate claims, namely claim 2 and claim 3.

### BRIEF DESCRIPTION OF THE SEVERAL VIEWS OF THE DRAWINGS

The present invention will now be described in detail with reference to the attached drawings, which are provided purely by way of non-limiting example, and in which:

FIG. 1 is a perspective view of a doorstop device provided with a tie rod obtained using a process according to the present invention;

FIG. 2 is a plan view of the tie rod indicated by the arrow II in FIG. 1;

FIGS. 3 and 4 are sections respectively according to the lines III-III and IV-IV of FIG. 2;

FIG. 5 is a partial schematic section of an apparatus for producing the tie rod illustrated in FIGS. 2 to 4; and

FIG. 6 is a partial perspective view of the part indicated by the arrow VI in FIG. 5.

### DETAILED DESCRIPTION OF THE ILLUSTRATED EMBODIMENTS

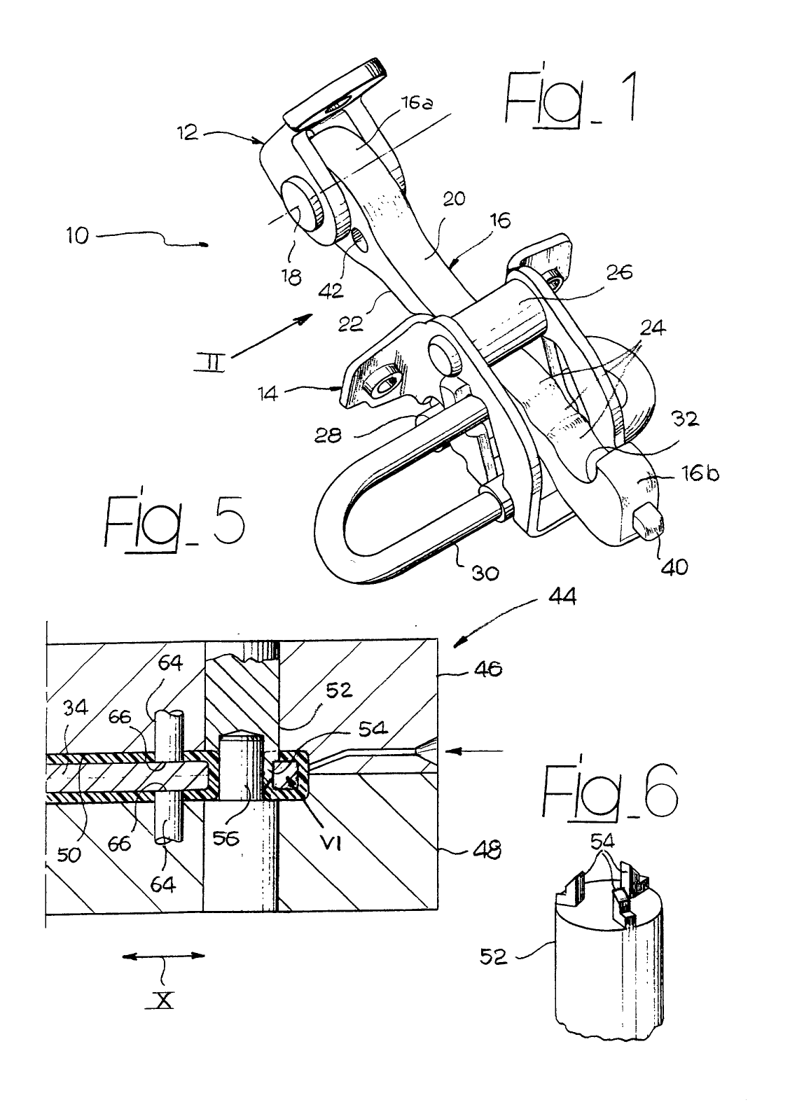

With reference initially to FIG. 1, the number 10 designates a doorstop device for an oscillating door of a vehicle, comprising, in a way of itself known, a first support 12 and a second support 14 designed to be fixed, respectively, to an upright and to a door of a vehicle.

A tie rod 16 has one first end 16a articulated to the first support 12 about an axis 18. The tie rod 16 has two rolling surfaces 20, 22 set opposite one another, in one of which a plurality of positioning notches 24 are made.

The second support 14 carries a pair of idle rollers 26, 28 which, in a way of itself known, are respectively pushed against the rolling surfaces 20, 22 by the elastic force produced by a torsion bar 30. The tie rod 16 has, at one second end, 16b an arrest seat 32.

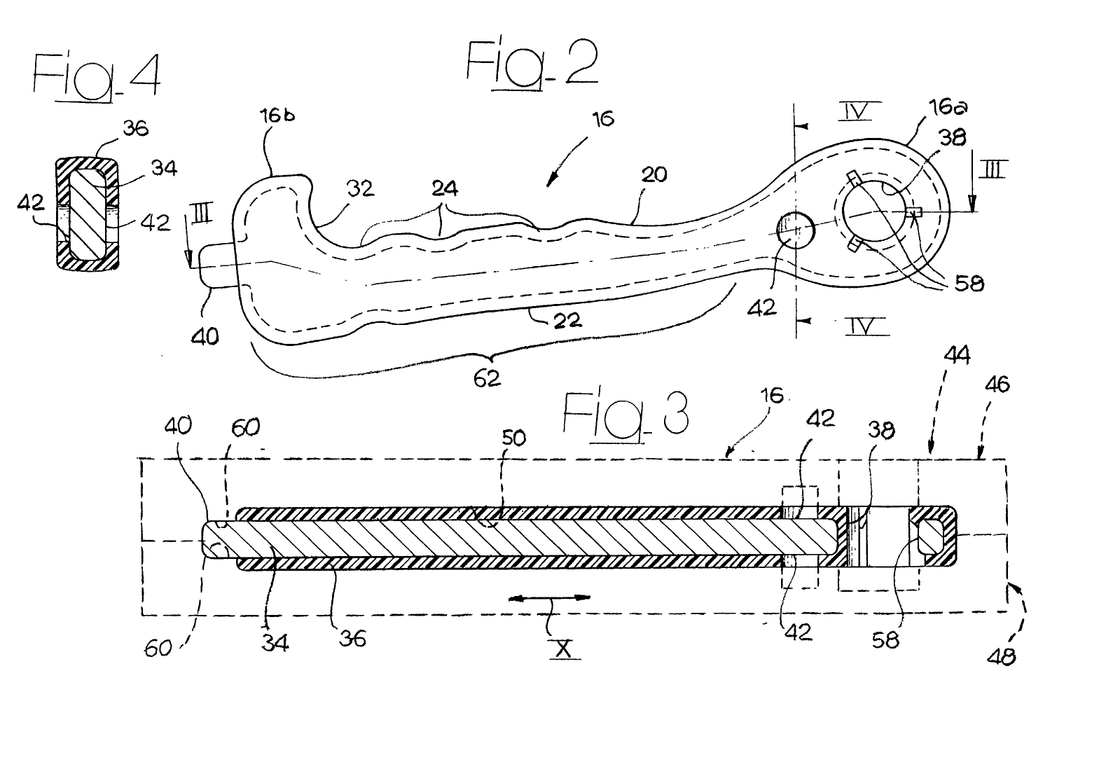

With reference to FIGS. 2, 3 and 4, the tie rod 16 comprises a metal core 34 on which is applied a coating 36 of plastic material. The tie rod 16 has an articulation hole 38 which serves for articulation to the first support 12. The inner surface of the hole 38 has the coating 36 of plastic material like the remaining part of the outer surface of the tie rod 16. The tie rod 16 further has a positioning appendage 40, which is not coated and which is set on the second end 16b.

With reference to FIGS. 3 and 5, the application of the coating 36 of plastic material on the core 34 is performed in an injection-moulding apparatus 44 which includes two half-moulds 46, 48. The half-moulds 46, 48 define a moulding seat 50 inside which is positioned the non-coated metal core 34, which is withheld in a centered position with respect to the moulding seat 50 by first, second, and third positioning means, which will be described in what follows.

With reference to FIGS. 5 and 6, the first positioning means comprise a pin 52 provided with three positioning teeth 54 which insert within the hole of the metal core 34, defining a precise positioning of the core 34 with respect to the moulding seat 50 in the direction of the longitudinal axis X. In a position set opposite to the positioning pin 52, a second positioning pin 56 is provided (FIG. 5), which inserts into the teeth 54 and forms an annular chamber with the inner wall of the hole of the metal core 34. During moulding, this annular chamber is filled with plastic material in such a way as to coat also the inner wall of the articulation hole. The coating is interrupted in the areas designated by 58 in FIGS. 2 and 3 on account of the presence, in these areas, of the positioning teeth 54. However, the said interruptions do not jeopardize the resistance of the coating of plastic material, given that the area of articulation is not subjected to high specific pressures during operation of the doorstop device. With reference to FIGS. 2 and 3, the positioning appendage 40 of the metal core 34 is set between two complementary seats 60 (FIG. 3) outside the moulding seat 50. The seats 60 constitute second positioning means which enable a precise positioning of the metal core 34 to be defined with respect to the moulding seat 50 in a direction transverse to the longitudinal axis X. During moulding, the appendage 40 projects outside of the moulding seat 50, so that this appendage is not coated with plastic material. The fact of providing, on the metal core 34, a projecting appendage that is not coated makes it possible to coat in a uniform way and without any discontinuity the entire part of the tie rod 16 which, in use, is subjected to high contact pressures. The lack of a part of coating in the part designated by 62 in FIG. 2 could, in fact, produce an initiation for failure of the coating.

To complete positioning of the metal core 34 with respect to the moulding seat 50, a pair of pins 64 set opposite one another could, moreover, be provided (FIG. 5); the said pins, which have plane resting surfaces 66, act on surfaces of the core 34 which are orthogonal to the rolling surfaces 20, 22 and which enable the end portion 16a to be positioned with precision in the Z direction. In the areas on which the pins 64 act, non-coated areas 42 are formed (FIGS. 2 and 3). The lack of coating in these areas does not jeopardize the integrity of the coating of plastic material, given that these areas are outside the portion 62 which, in use, is subjected to the action of the rollers 26, 28.

After the non-coated metal core 34 has been inserted between the half-moulds 46, 48, the latter are closed, and the metal core 34 is positioned precisely with respect to the moulding seat 50. This positioning guarantees that, during the injection of plastic material, there is formed a coating with a uniform thickness over the entire surface of the metal core 34 that is not in contact with the positioning means. The coated tie rod thus produced presents very high resistance and durability and a very small risk of damage to the coating of plastic material even after prolonged use.

1. A process for the production of a coated tie rod for a doorstop device for vehicles, in which the tie rod has an articulation hole at one first end and a pair of rolling surfaces designed to cooperate with a pair of rollers, the said process comprising the steps of positioning a metal core in a moulding apparatus, and injecting plastic material into a moulding seat surrounding the metal core, the metal core being positioned with respect to the moulding seat using first positioning means which cooperate with the articulation hole, and using second positioning means which cooperate with an appendage formed at a second end of the metal core, said appendage protruding outside said moulding seat.

2. The process according to claim 1, comprising third positioning means including a pair of pins set opposite one another, which act on surfaces of the metal core orthogonal to said rolling surfaces.

3. The process according to claim 1, wherein the first positioning means comprise a plurality of teeth which insert inside a hole of the metal core.
